(19) United States
(12) Patent Application Publication
(10) Pub. No.: US 2007/0085029 A1
(43) Pub. Date: Apr. 19, 2007

(54) DC only tool cell with a charged particle beam system

(76) Inventors: Bruce B. Baxter, San Mateo, CA (US); Benyamin Buller, Cupertino, CA (US)

Correspondence Address: PATTERSON & SHERIDAN, LLP, 3040 POST OAK BOULEVARD, SUITE 1500, HOUSTON, TX, 77056, US

(21) Appl. No.: 11/241,232

(22) Filed: Sep. 30, 2005

(51) Int. Cl. G21G 5/00

(52) U.S. Cl. 250/492.1

(57) ABSTRACT

Systems, methods, and apparatus for reducing EMI in charged particle beam systems are provided. By placing noise sensitive electronic modules used in charged particles systems in a shielded equipment cell, and routing DC only signals to power the modules, EMI within the housing may be significantly reduced.

### FIELD OF THE INVENTION

This invention relates to charged particle beam systems and more specifically, it relates to charged particle beam systems with reduced electromagnetic interference (EMI).

Charged particle beam lithography and inspection systems are well-known systems used in multiple industrial fields. For example, charged particle beam inspection systems are used for surface examination of semiconductor materials, while charged particle beam lithography systems are used for patterning in the fabrication of semiconductor integrated circuits. Such charged particle beam lithography systems typically include a beam control system, a high speed deflection and blanking system, an electrostatic deflection module, detectors, beam steering and forming elements in a column, a stage for a semiconductor wafer or mask (a workpiece), and a mechanism to move the stage with respect to the beam.

FIG. 1 illustrates an exemplary charged particle beam system 100. In order to write with the charged particle beam system 100, an electron beam directed through a beam column 108 is scanned back and forth across the surface of a workpiece (not shown) placed on stage 104 with the beam turning on and off at appropriate times to create the desired pattern in an electron sensitive resist layer. System control logic 110 may enable a high speed deflection and blanking system 101, a gun 109 and a beam control system 107 to control the exposure to create a desired pattern. In other methods of writing, the beam is deflected to positions at which pattern elements are to be exposed and individual pattern elements are written in a raster fashion. An electrostatic deflection module 102 may be controlled by the system control logic 110 to sweep the beam that has traveled through the upper portion of the column 108 in order to write each pattern element.

During a writing phase, the stage 104 may move along an axis while a beam is swept along another axis on a sample located on stage 104. The stage speed may be controlled to create an appropriate “aspect ratio” between exposure dimensions in the axis of stage motion and exposure dimension in the axis on which the beam is swept. Other such systems may utilize a different writing technique. In other systems, the stage 104 is generally stationary, and writing takes place over a limited field, typically square in shape. Once the writing of the field is completed, the stage 104 is moved to a new location, and another field is written. Similarly, in inspection systems, a charged particle beam is deflected to positions of a workpiece. Then, secondary charged particles generated by the beam exposure are detected using detectors 105 to form an image.

It is well-known in the art that some of the components of a charged particle beam system, such as the beam control system, the high speed deflection and blanking system, the electrostatic deflection module, the detectors, beam steering and forming elements in a column, are very sensitive to EMI. EMI is electromagnetic radiation which is emitted by electrical circuits carrying rapidly changing signals, as a by-product of their normal operation, causing unwanted noise or interference to be induced in other circuits. The noise or interference caused by EMI may interrupt or otherwise degrade or limit the effective performance of some of the noise sensitive components and ultimately compromise the writing or inspection.

The suppression of EMI on certain components of the system has become an important task in the design phase of charged particle beam systems. The EMI interference or noise on sensitive portions of charged particle beam systems can originate from various components within the system, such as drive electronics or from nearby signal transmission sources. For example, as shown in FIG. 1, AC to DC power converters 116a, 116b, switch mode DC to DC converters 111 and 113 can generate EMI as a by-product of their normal operation. EMI on beam deflectors can degrade the quality of beam position control. In addition, EMI found on lens drives, beam source components, and detectors may degrade the control of focus and thus, can adversely affect the resolution of the pattern or image generation.

Designers of conventional charged particle systems have addressed this problem by introducing a shield (a metal housing) enclosing each EMI sensitive component to prevent EMI generated from surrounding modules, which are powered by alternating current (AC), from penetrating the sensitive Direct Current (DC) powered components. For example, as illustrated in FIG. 1, high speed deflection and blanking system 101, column 108, gun 109, deflection module 102, and beam control system 107 are individually shielded (as indicated by dash lines). In addition, in some embodiments, AC to DC power converters 116a and 116b, AC voltage regulator 112 and switch mode DC to DC converters 111, 113 may be shielded to reduce radiated EMI that may adversely affect noise sensitive components of charged particle beam systems. As shown in FIG. 1, the conventional approach requires shielding each noise sensitive module individually. Other conventional approaches may require shielding of a group of noise sensitive components of a charged particle system where both AC and DC power signals are routed within a single shielded housing. These approaches are not ideal as they pose significant design constraints on the overall system. These approaches increase the difficulty of achieving the desired degree of isolation for noise sensitive components, and as a result may either increase the overall cost of manufacture or decrease the performance of the resulting system.

Accordingly, an improved system with an improved shielding of charged particle beam systems is needed. In particular, it would be desirable to have a system which effectively isolates sensitive components from EMI sources through physical separation and in turn decreases the adverse effects of EMI in charged particle pattern generation and inspection systems more effectively.

### SUMMARY OF THE INVENTION

Embodiments of the present invention provide systems, methods, and apparatus for reducing EMI in charged particle beam systems.

One embodiment provides a charged particle beam system generally including power supply for generating a plurality of DC power signals from an external power source, a charged particle beam source for providing a charged particle beam, a movable stage for moving a workpiece relative to the charged particle beam, and a charged particle beam column for directing the charged particle beam onto the workpiece. An electrically shielded equipment housing encloses at least the beam source, stage, and column, wherein the equipment cell includes one or more conduits for feeding through DC power signals from the power supply to power at least the beam source, stage, and column.

Another embodiment provides a DC only equipment cell for use in a charged particle beam system generally including a charged particle beam source for providing a charged particle beam, a movable stage for moving a workpiece relative to the charged particle beam, a charged particle beam column for directing the charged particle beam onto the workpiece, and an electrically shielded housing. The housing encloses the beam source, stage, and column, wherein the equipment cell includes one or more conduits for feeding through DC only power signals from an external power supply to power at least the beam source, stage, and column.

Another embodiment provides a method of controlling electromagnetic interference (EMI) in a charged particle beam system. The method generally includes enclosing, within a shielded equipment housing, at least a charged particle beam source for providing a charged particle beam, a movable stage for moving a workpiece relative to the charged particle beam, and a charged particle beam column for directing the charged particle beam onto the workpiece and feeding a plurality of DC only power signals into the housing to power the charged particle beam source, movable stage, and components within the column.

### BRIEF DESCRIPTION OF THE DRAWINGS

So that the manner in which the above-recited features, advantages and objects of the present invention can be understood in detail, a more particular description of the invention, briefly summarized above, may be had by reference to the embodiments thereof which are illustrated in the appended drawings.

FIG. 1 is a block diagram of a prior art embodiment of a charged particle beam system described herein;

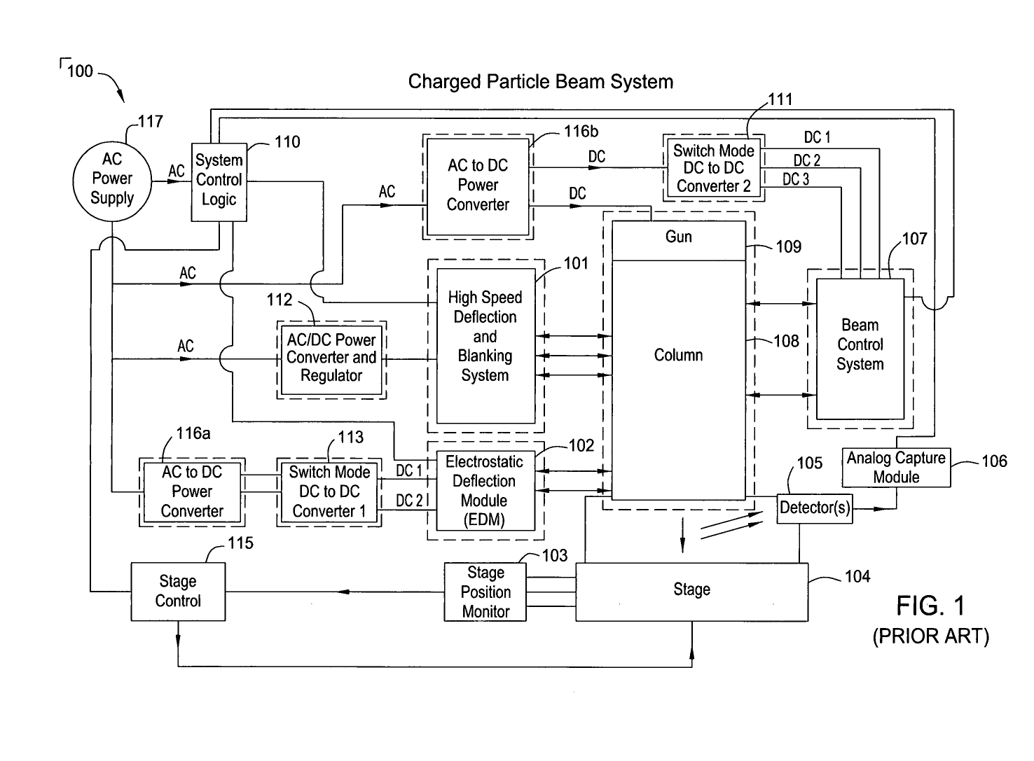

FIG. 2 is a block diagram of a charged particle beam system incorporating a first embodiment of the present invention described herein;

FIG. 3 is a block diagram of a charged particle beam system incorporating a second embodiment of the present invention described herein; and

FIG. 4 is a general block diagram of a charged particle beam system incorporating the present invention described herein.

### DETAILED DESCRIPTION

Embodiments of the present invention may be used to reduce EMI in charged particle beam systems by placing noise sensitive electronic modules used in charged particles systems in a shielded equipment cell. For some embodiments, only DC powered signals may be routed into the cell.

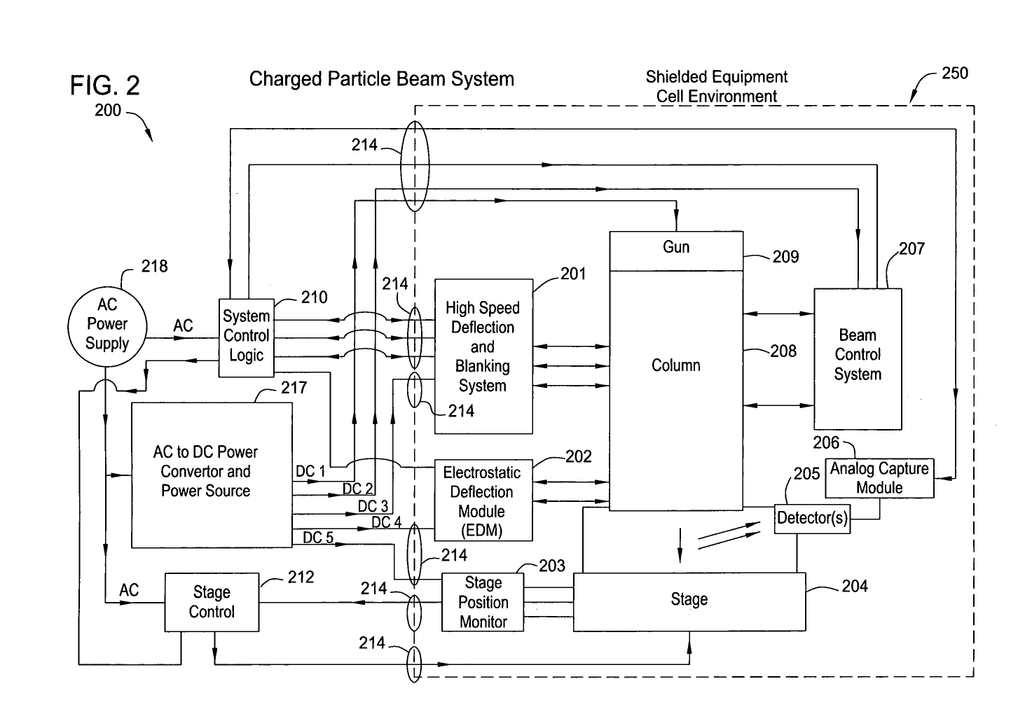

FIG. 2 shows a block diagram of an exemplary charged particle beam system 200 in accordance with an embodiment of the present invention. As illustrated, noise sensitive electronic modules, such as a high speed deflection and blanking system 201, a column 208, a gun 209, a beam control system 207, analog capture module 206, a stage 204, detectors 205, a stage position monitor 203 and an electrostatic deflection module 202, used in the system 200, may all be housed in a shielded equipment cell 250. On the other hand, the components, which are not typically sensitive to noise, such as system control logic 210, stage control 212, and AC to DC power converter 217 and AC power source 218 may be positioned outside the shielded equipment cell 250.

In one embodiment of the present invention, only DC power signals are connected to the components within shielded equipment cell 250 through conduits 214. All other components, such as the AC to DC power converter 217, AC power supply 218 and system control logic 210, capable of emitting EMI, are excluded from and are located outside the shielded equipment cell 250. In addition, all required thermal regulation of components within the shielded equipment cell 250 is accomplished by utilizing linear DC drive currents instead of AC relays or SCR based heater drives.

In one embodiment of the present invention, an electron beam generated by the gun 209 is directed through the column 208. Apertures (not shown) within the column 208 limit the beam to create shaped projections of the apertures which in turn combine to form a shape (e.g., square). The high speed deflection and blanking system 201 controls the deflection of the beam through the apertures and allows the beam to shape before the beam reaches the target located on stage 204. In addition, the high speed deflection and blanking system 201 controls the exposure time of the beam on the target. The high speed deflection and blanking system 201 is capable of moving the beam slightly within a predefined range to adjust the beam position and optimize beam exposure in order to allow different shapes with different sizes to be placed within a given “field” of exposure. The high speed deflection and blanking system 201 may utilize DC voltages ranging from 1.5 up to 24 volts for operation. As shown in FIG. 2, an AC to DC power converter and power source 217 can provide a plurality of different voltages for the high speed deflection and blanking system 201, as well as other components within the shielded equipment cell 250.

While not shown in FIG. 2, the components inside the high speed deflection and blanking system 201 generally include other components such as digital to analog converters, which can produce a limited level of noise. Thus, the high speed deflection and blanking system 201 may include internal shielding to keep digital switching from contaminating nearby components. However, any noise or EMI emitted by such components within the high speed deflection and blanking system 201 is very minimal and typically incapable of generating a significant amount of EMI at least relative to the amount of EMI generated by components that are positioned outside the shielded equipment cell 250.

An electrostatic deflection module 202 sweeps the beam that has traveled through the upper portion of the column 208, shaped by the high speed deflection and blanking system 201, and formed by the apertures. Electrostatic deflection module 202 may correct the beam position while the system is scanning during normal operation. The electrostatic deflection module 202 may utilize voltages ranging from 1.5 up to 150 volts for operation. An AC to DC power converter and power source 217 can provide a plurality of different voltages (both positive and negative voltages) for the electrostatic deflection module 202.

In one embodiment, system control logic 210 may control the electrostatic deflection module 202 to control scanning of the formed shape through the exposure field for pattern generation. While not shown in FIG. 2, the components inside the electrostatic deflection module 202 generally include other components such as digital decoders, low pass filters, signal amplifiers, digital to analog converters, and analog to digital converters for communication with system control logic 210 and column 208. Therefore, the electrostatic deflection module 202 may include internal shielding to keep digital switching from contaminating nearby components. However, any noise or EMI emitted by such components within the electrostatic module 202 is very minimal and typically incapable of generating a significant amount of EMI at least relative to the amount of EMI generated by components that are positioned outside the shielded equipment cell 250.

Beam control system 207 manages all of the internal mechanisms within column 108. The Beam control system 207 provides coil current required to adjust and maintain optimized beam focus, intensity, and alignment. Similar to other EMI sensitive components, beam control system 207 may include shielding to keep any digital switching from contaminating nearby components that may be created by components within the beam control system 207.

An analog capture module 206 may be included to capture signals from detectors 205 and provides the collected data to a computer system (not shown) outside the shielded equipment cell 250. In some embodiments of the present invention, the system may also include a high frequency signal lines, which transfers collected data by detectors 205 directly to a computer system (not shown) outside the shielded equipment cell 250.

Stage position monitor 203 controls the stage 204 and is capable of moving the stage 204 in at least X and Y directions. In one embodiment, stage position monitor 203 may include a magnetic propulsion mechanism (not shown).

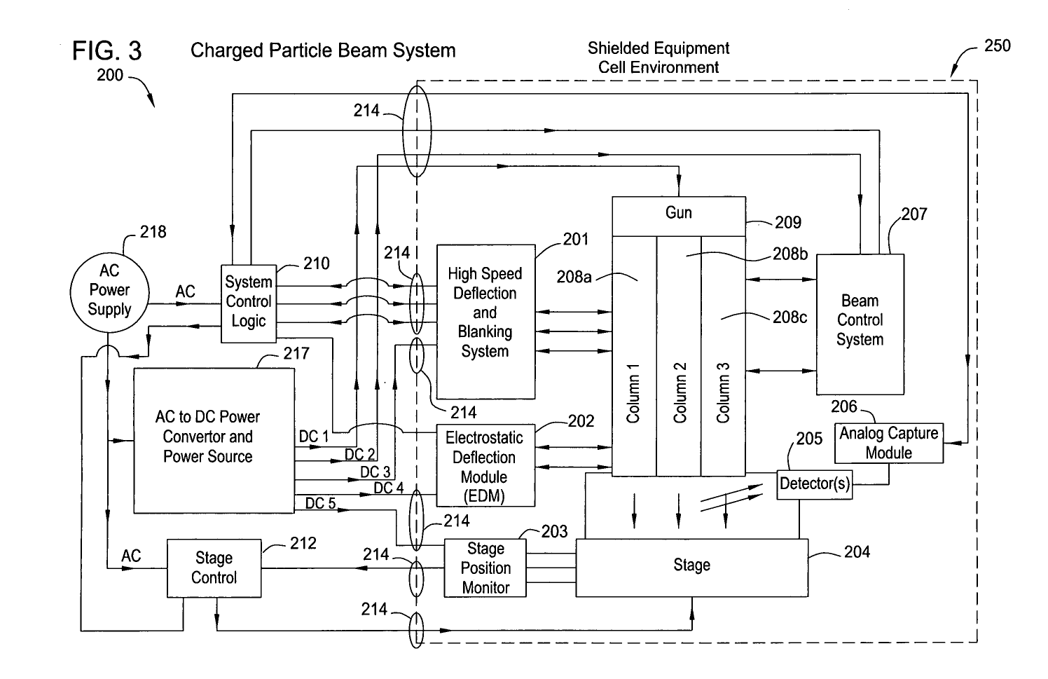

FIG. 3 shows a block diagram of an exemplary charged particle beam system in accordance with another embodiment of the present invention. FIG. 3 is similar to the configurations illustrated in FIG. 2 except for additional columns 208a, 208b and 208c, thus, like elements numbers have been used where appropriate. As shown, a multiple column charged particle beam system may be included within the shielded equipment cell 250.

One exemplarily configuration of the present invention may include a shielded tool cell with dimensions of 3.85 m width, 3.13 m depth and 4.0 m in height. However, those skilled in the art will recognize the shielded tool cell described herein may be made in other dimensions.

While embodiments of the present invention have been described with reference to charged particle beam systems, those skilled in the art will recognize that the concept described herein may also be applied to advantage when utilizing noise sensitive electronic modules in various other electronic systems.

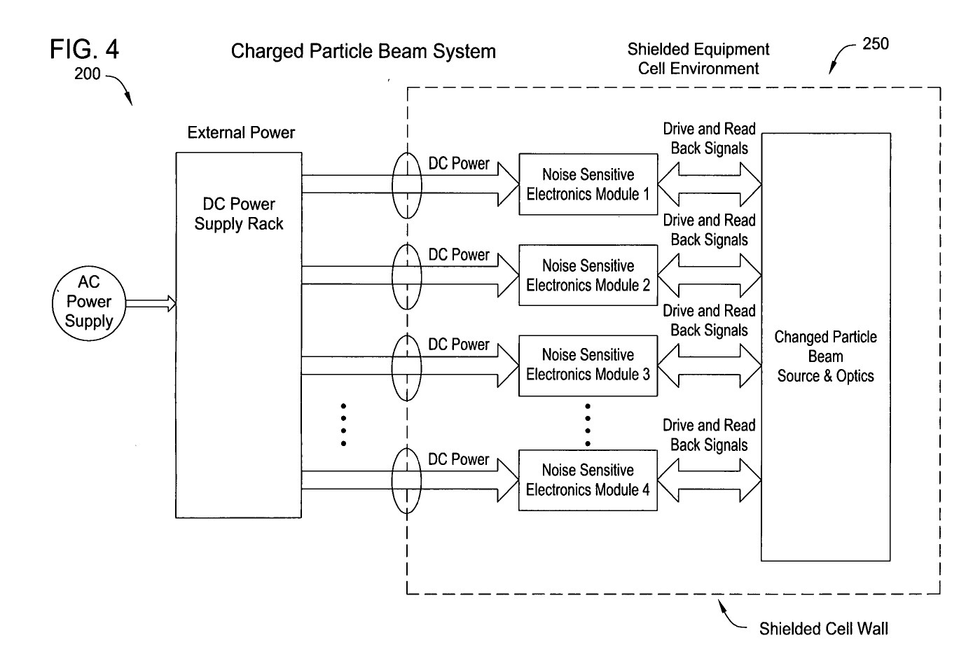

FIG. 4 illustrates a general system with sensitive electronic modules within a cell and all other components, which are not typically sensitive to noise, such as the DC power supply rack and AC power source positioned outside the shielded cell. The general system design based on the present invention as shown in FIG. 4 may be utilized in various EMI sensitive systems. For example, the present invention can be used in scanning electron microscope. It is well-known in the art that the electron beam in scanning electron microscope is easily bent by magnetic fields. Therefore, when utilizing the present invention in an SEM system, all AC to DC converters, and signal amplifiers may be placed outside a cell, while noise sensitive components including the column, detection circuitry and deflection modules may be placed in the cell in an attempt to ensure EMI does not cause signal degradation.

While the foregoing is directed to embodiments of the present invention, other and further embodiments of the invention may be devised without departing from the basic scope thereof, and the scope thereof is determined by the claims that follow.

What is claimed is:

1. A charged particle beam system, comprising:
a power supply for generating a plurality of DC power signals from an external power source;
a charged particle beam source for providing a charged particle beam;
a movable stage for moving a workpiece relative to the charged particle beam;
a charged particle beam column for directing the charged particle beam onto the workpiece; and
an electrically shielded equipment housing enclosing at least the beam source, stage, and column, wherein the equipment cell includes one or more conduits for feeding through DC power signals from the power supply to power at least the beam source, stage, and column.

2. The system of claim 1, wherein the external power source is an AC power source.

3. The system of claim 1, wherein no switching DC to DC voltage converters are contained in the equipment cell.

4. The system of claim 1, further comprising:
stage position monitoring circuitry enclosed in the equipment housing and powered from one of the DC signals.

5. The system of claim 4, further comprising:
control logic, located outside the equipment housing, for controlling movement of the stage and components of the column to control direction the beam based, at least in part on data from the stage position monitoring circuitry.

6. The system of claim 5, further comprising:
interface lines routed through the equipment cell allowing communication between the control logic and at least the stage position monitoring circuitry.

7. The system of claim 1, further comprising detectors positioned to detect secondary charged particles generated in response to the beam striking the workpiece.

8. The system of claim 7, further comprising:
analog capture circuitry, located within the equipment housing, for capturing data from the detectors; and
interface lines routed through the equipment housing allowing communication between the control logic and at least the analog capture circuitry

9. The system of claim 8, further comprising interface lines allowing data to be routed from the detectors to the control logic while bypassing the analog capture circuitry.

10. A DC only equipment cell for use in a charged particle beam system, comprising:
a charged particle beam source for providing a charged particle beam;
a movable stage for moving a workpiece relative to the charged particle beam;
a charged particle beam column for directing the charged particle beam onto the workpiece;
an electrically shielded housing enclosing the beam source, stage, and column, wherein the equipment cell includes one or more conduits for feeding through DC only power signals from an external power supply to power at least the beam source, stage, and column.

11. The equipment cell of claim 10, wherein the external power supply generates at least some of the DC power signals from an AC power source.

12. The equipment cell of claim 10, wherein no switching DC to DC voltage converters are contained in the equipment cell.

13. The equipment cell of claim 10, further comprising:
stage position monitoring circuitry enclosed in the equipment housing and powered from at least one of the DC signals.

14. The equipment cell of claim 10, further comprising detectors positioned to detect secondary charged particles generated in response to the beam striking the workpiece.

15. The equipment cell of claim 14, further comprising:
analog capture circuitry, located within the equipment cell, for capturing data from the detectors; and
interface lines routed through the equipment cell allowing communication between the control logic and at least the analog capture circuitry

16. A method of controlling electromagnetic interference (EMI) in a charged particle beam system, comprising:
enclosing, within a shielded equipment housing, at least a charged particle beam source for providing a charged particle beam, a movable stage for moving a workpiece relative to the charged particle beam, and a charged particle beam column for directing the charged particle beam onto the workpiece; and
feeding a plurality of DC only power signals into the housing to power the charged particle beam source, movable stage, and components within the column.

17. The method of claim 16, further comprising:
controlling movement of the stage with control logic located outside the equipment housing.

18. The method of claim 17, further comprising:
feeding network interface lines into the housing for communication between the control logic and position monitoring circuitry located within the housing.

19. The method of claim 16, further comprising:
generating the DC power signals from an AC power signal.

20. The method of claim 16, further comprising regulating the temperature of one or more components inside the housing utilizing linear DC drive currents.
